(19) United States
(12) Patent Application Publication
(10) Pub. No.: US 2003/0015822 A1
(43) Pub. Date: Jan. 23, 2003

(54) Method for constructuring waterproof footwear

(75) Inventors: Robert G. Rinehart JR., La Crosse, WI (US); Robert G. Cropp JR., West Salem, WI (US); Jerome M. Hess, Onalaska, WI (US)

Correspondence Address: FOLEY & LARDNER, 777 EAST WISCONSIN AVENUE, MILWAUKEE, WI, 53202, US

(73) Assignee: LaCrosse Footwear, Inc.

(21) Appl. No.: 10/079,921

(22) Filed: Feb. 20, 2002

Related U.S. Application Data
(60) Provisional application No. 60/270,726, filed on Feb. 22, 2001.

(51) Int. Cl. B29D 31/50

(52) U.S. Cl. 264/244

(57) ABSTRACT

A process for manufacturing an article of waterproof footwear such as a boot is provided. The bottom of the lower where the sole is attached is initially left open so that any seams can be sealed watertight and any additional features, such as insulation and liners, can be added in an easier and more precise manner. The present method also makes it easier to custom fit footwear and make footwear in half sizes by taking the guesswork out of determining the actual inner dimensions of the footwear because these dimensions can be directly observed.

### FIELD OF THE INVENTION

This invention relates to a method for manufacturing an article of waterproof footwear. More particularly, this invention provides a process for manufacturing an article of waterproof footwear by allowing access to the interior of the footwear through a lower opening where the sole is later attached.

### BACKGROUND OF THE INVENTION

There has been an explosion in sales of waterproof footwear over the last few years. Waterproof footwear, and especially waterproof boots, are useful in many applications to keep the foot of the user dry and comfortable in wet conditions. Many different methods of waterproofing footwear have been attempted and include using waterproof materials, such as rubber, to construct the footwear, incorporating waterproof liners into the footwear and treating conventional materials, such as leather and fabric, with waterproofing treatments. However, it has proven difficult to completely waterproof footwear for a vast number of reasons—rubber splits, liners wear out or are not watertight to begin with, seams leak, etc. Waterproofing seamed footwear, and particularly that made out of leather, has proven to be particularly troublesome because seams often take the brunt of the wear and are difficult to access and thus seal.

It is also difficult to fit boots intended for heavy duty use, especially hiking boots. As any experienced hiker knows, the ins and outs of fitting a boot to a particular person's needs is very difficult and time consuming. Hiking books are not fitted primarily on the listed size, as is other footwear, but are fitted instead on a complex combination of desired use, rubbing and at least a minimal period of actually wearing the footwear. These problems are further aggravated because the manufacture of footwear is much more imprecise than manufacturers would lead consumers to believe. The size of a piece of footwear made from the same sized pieces of material can vary greatly, from a whole shoe size or more. Thus, one piece of footwear labeled as a particular size may not fit the same as another piece of footwear of the same size. This is particularly troublesome where many lining elements, for example insulation, are incorporated into footwear because the manufacturer cannot easily measure the exact contours and dimensions of the interior of footwear once it is made. Based on these problems, there is a great need in the art of footwear manufacture to more easily produce an article of waterproof footwear while at the same timing providing a more precise fit to the end user.

### SUMMARY OF THE INVENTION

One embodiment of the present invention provides an improved method for manufacturing waterproof footwear. According to the present method, an article of waterproof footwear is constructed by shaping a lower from at least one piece of material by joining the material with at least one seam. The thusly formed lower has an upper circumference which defines a top opening and a lower circumference which defines a lower opening. The upper circumference is attached to a complementary lower portion of an upper by a second seam. At least the lower is sealed in a waterproof manner and the bottom opening of the lower is also sealed to form a footbed. The method may further comprise any or all of: attaching an outsole, which can be a lug outsole, to the footbed of the footwear; disposing a liner, which is optionally waterproof, adjacent to an inner surface of the upper or lower through the bottom opening of the lower; and sealing the at least one seam and second seam in a waterproof manner by accessing the seams through the bottom opening of the lower.

The material used in the present invention can be any or all of planar, waterproof in its own right, a single piece, rubber, a polymer, leather, waterproof leather, U-shaped, and molded. If rubber, the material can be vulcanized, either before or after the material is incorporated into the footwear. Additionally, the seams can be stitched, located in a heel portion of the lower, or sealed watertight through the bottom opening of the lower

The above described embodiments are set forth in more detail in the following description and illustrated in the drawings described hereinbelow.

### BRIEF DESCRIPTION OF THE DRAWINGS

The preferred exemplary embodiment of the invention will hereinafter be described in conjunction with the appended drawings, wherein like numerals denote like elements and:

FIG. 1a. is a plan view of a preferred piece of material for forming into a lower of the present invention;

FIG. 1b. is a plan view of the piece of material of FIG 1a. formed into a lower according to the present invention;

FIG. 2 is a perspective view, partially in elevation, of a lower and an upper according to the present invention;

FIG. 3 is an exploded view of a boot made according to the present invention;

FIG. 4 is a perspective view of a boot made according to the present invention where the lower opening has not yet been sealed;

FIG. 5 illustrates the prior art method for inserting liners into footwear; and

FIG. 6 is a side view of footwear produced according to the present invention after the bottom opening is sealed.

### DETAILED DESCRIPTION OF THE INVENTION

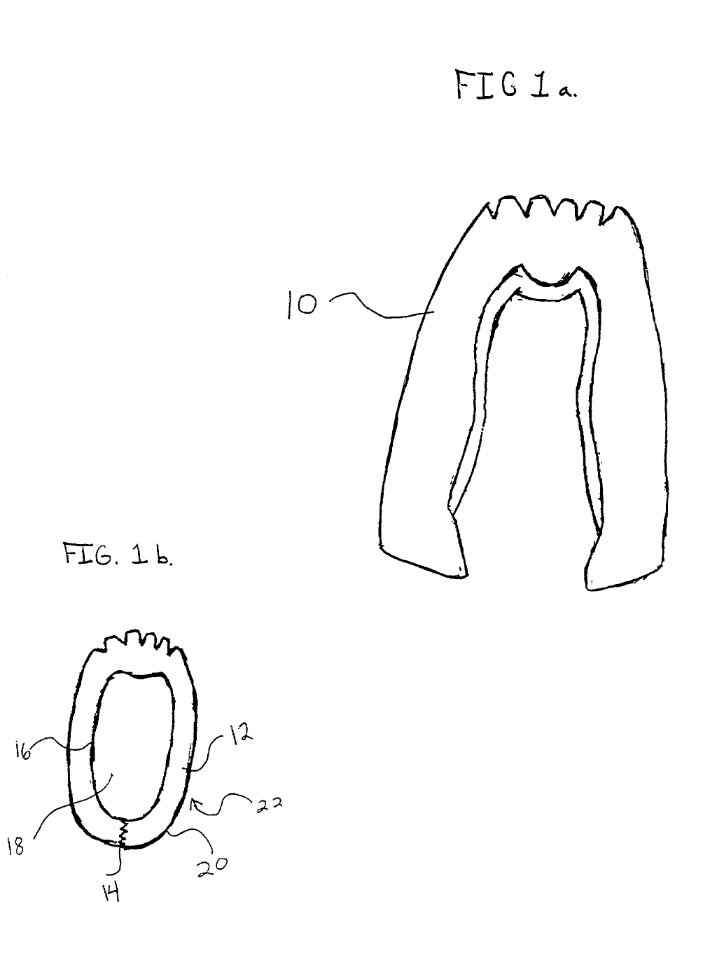

Referring to the diagrams, a piece of material 10 is shaped into a lower 12 by joining the ends of the material together as shown in FIGS. 1a. and 1b. Typically, the lower will be formed over a last (not shown), as is well known in the art. The piece of material is shown in FIG. 1a. in the preferred embodiment wherein the material is basically a flat, or substantially planar, U-shaped piece of material. However, the material can take on any number of other configurations as would be appreciated by one skilled in the art. Preferred materials for the material include rubber, vulcanized rubber, waterproof leather, and polymers, although the invention is not limited to these materials. Because rubber is a preferred material and can make up most of the components of the finished footwear, vulcanization can occur at many stages in the process, including: prior to forming the lower 12; joining any of the pieces together; after the boot is completely finished; or any step in between. As will be apparent to one skilled in the art, vulcanization should not be performed on an assembled or partially assembled boot where the vulcanization conditions would be detrimental to any boot materials or construction. Suitable polymers include urethanes, polyesters, nylon and PVC. Although not required by the present invention, the material 10 is preferably waterproof with or without additional treatment. When rubber or a polymer is used, the material can be molded according to processes well known in the art to provide the surface of the material on the exterior of footwear with attractive raised patterns as desired. Patterns can also be achieved in leather according to methods known in the art, such as, for example, stamping, although textured leather tends not to provide the detail which can be achieved with rubber or polymers. Patterns molded or stamped into the material are not limited to merely aesthetic value, but can also provide functionality to the article of footwear, for example by providing points of attachment.

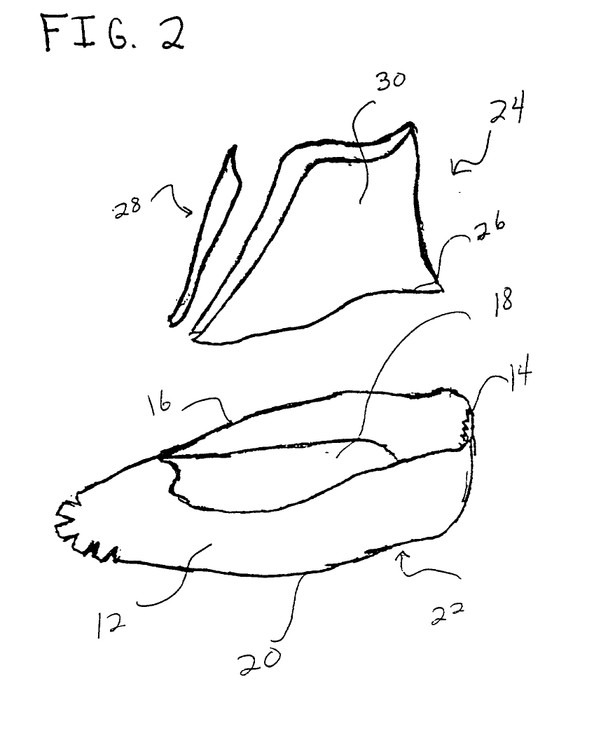

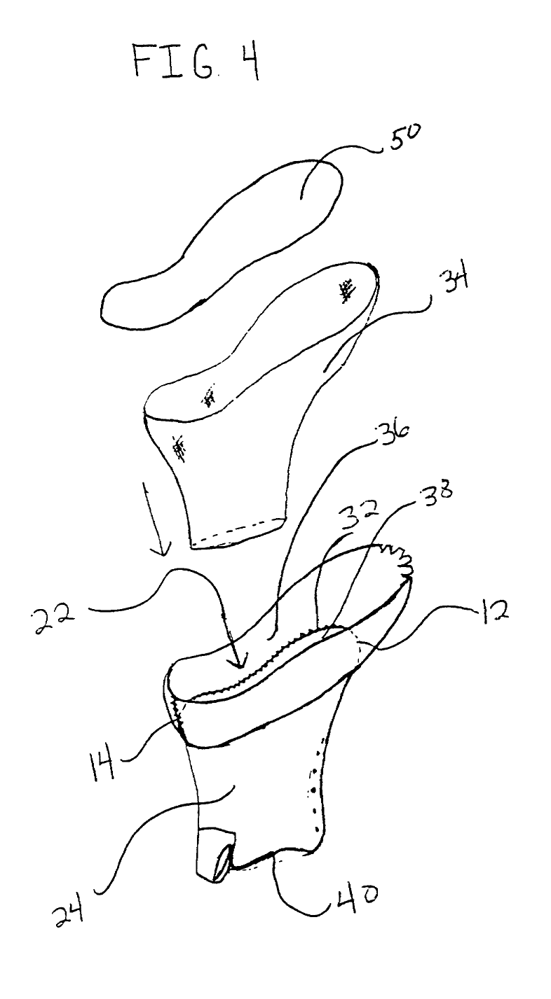

The lower 12 is formed by joining the material 10 with at least one seam 14. As can bee seen from the diagram, the lower has an upper circumference or periphery 16, which defines an upper opening 18, and a lower circumference or periphery 20 that defines a bottom opening 22. Bottom opening 22 can be more easily seen in FIGS. 2 and 4 although the substance of the lower as described is easily visualized. Preferably, seam 14 is achieved through stitching. When seam 14 is stitched, the material used must be capable of holding a stitch. In footwear where rubber is used for the material 10, typically the rubber is fabric backed. A suitable seam 14 can also be achieved according to other methods, including, but not limited to, using an adhesive or melting the ends of the material together. Obviously, when adhesives are used they must be compatible with the material 10. Likewise, when the ends of the material 10 are melted together to form the seam 14 a material capable of withstanding this treatment must be used, for example a thermoplastic. Advantageously, only a single piece of material 10 is used so that only a single seam 14 is formed in making the lower 12. Producing the lower in this manner minimizes the number the of seams to be sealed watertight, thus reducing labor costs and the chance that the final article of footwear will lose its waterproof characteristics. Although not preferred, lower 12 can be made up of a plurality of pieces (not shown) of material 10. However, an increase in the number of pieces of material will result in a corresponding increase in the number of seams which must be formed and subsequently sealed. In this less preferred embodiment, the plurality of pieces of material which make up the lower can be of different types of materials to achieve desired aesthetic and functional characteristics, such as improved durability or support. For example, a heel portion of the lower 10 can be made of a piece rubber or polymer whereas the toe portion of the lower can be of leather. Additionally, other pieces of material can make up the instep portion, outer portion, or the like. Joining different materials together to form the lower 12 can provide a virtually limitless number of material combinations and placements as understood by one skilled in the art.

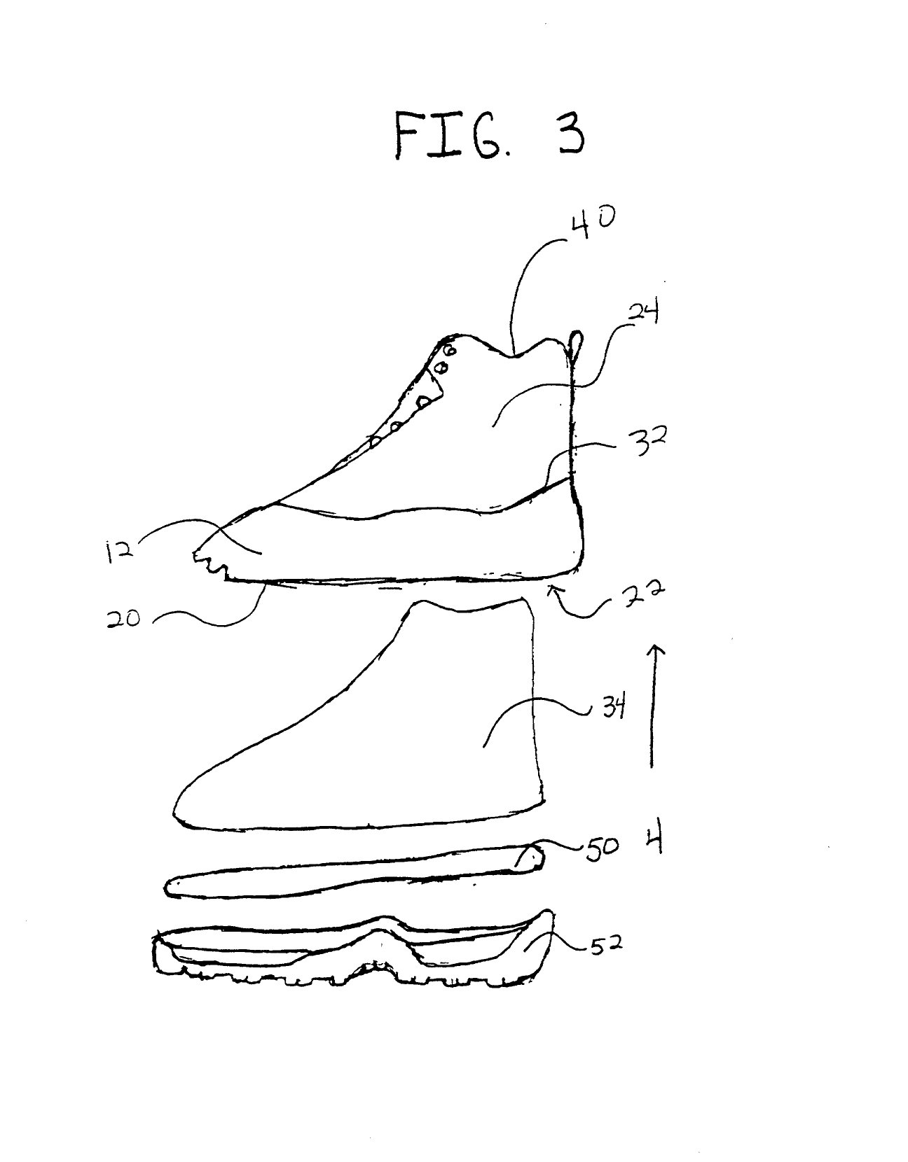

To produce a boot according to the present invention, the lower 12 is preferably attached to an upper 24. Typically, the upper periphery 16 of lower 12 is attached to a complementary lower portion 26 of the upper 24 via a second seam 32, shown in FIG. 3. Upper 24 and lower 12 can be attached by any previously discussed method or any other method known in the art. Although upper 24 is shown in FIG. 2 as two pieces, a tongue portion 28 and an ankle protecting piece 30, this is not preferred because providing the upper in this manner provides additional sites for water infiltration in the finished product. Accordingly, the upper 24 is preferably a single piece of material. Upper 24 can be any suitable material and is preferably a material mentioned previously. It is also desirable that the material used to make upper 24 is waterproof. Although the boot formed according to the present invention is shown as having both an upper and a lower, the boot need not have an upper, provided that the piece of material 10 used to produce the lower 12 is suitably shaped and in sufficient quantity to provide enough material to cover the foot and possibly ankle and calf of a wearer of the footwear. Alternatively, when both a lower 12 and an upper 24 are used, the material 10 of the lower 12 and upper 24 can be joined together by a seam 32 prior to completely forming the lower 12 with seam 14. Attaching the upper 24 to the lower 12, prior to sealing bottom opening 22 allows the upper and lower to be attached by seam 32 in a more efficient manner. Instead of sewing the seam 32 through foot opening 40, the sewing machine arm (not shown) can be inserted through the larger bottom opening 22. In this manner the operator of the sewing machine can directly view the seam 32 on the interior of the footwear and thus less skill and concentration is required to form the seam 32 than in previous methods.

Prior to completing the article of footwear according to the present invention, at least the lower 12 of the footwear is sealed in a waterproof manner. Preferably the upper 24, and the completed boot, is also sealed watertight. Making the lower 12 waterproof can be accomplished through many procedures depending upon the materials used and the configurations of both the lower 12 and upper 24. These procedures are best understood by explanation viewed in combination with FIG. 4. Preferably, when the lower 12, and optionally the upper 24 as well, is made of waterproof materials, waterproofing at least the lower is done by sealing the interior portion of the at least one seam 14 and, optionally, the second seam 32 in a watertight fashion. These seams can be sealed with liquid bond, waterproof tape or a combination of the two as is known in the art. As will be understood by a person of ordinary skill in the art, waterproofing the at least one seam 14 and the second seam 32 will not provide the article of footwear with complete waterproof protection unless water is prevented from entering through opening 22. Alternatively, a watertight sealing of at least the lower can be achieved by disposing a waterproof liner 34 adjacent to an interior portion 36 of the lower, and preferably the upper as well, by inserting the liner 34 through the bottom opening 22. FIG. 3, which is an exploded view of a boot made according to the present invention, also illustrates this concept. Inserting a waterproof liner 34 is preferred when the materials used to make up the boot are not waterproof by themselves. Alternatively, when the boot material is waterproof and the seams are sealed watertight, as described above, the liner 34 need not be waterproof but can provide functional characteristics to the boot, for example, insulating capability. To provide superior water protection to the boot, both the seams can be sealed and a waterproof liner 34 can be used. Suitable waterproof liners, for example Neoprene®, are well known in the art and can also be breathable, such as is achieved with Gore-Tex®. The waterproof liner 34 can also extend up into the boot thereby residing adjacent to an interior portion 38 of the upper. When a liner 34 is provided to waterproof at least the lower, preferably the liner will be a complete booty including a sole so as to completely surround the foot of the user in the waterproof liner as shown in FIG. 4.

It is in performing the process of sealing the at least the lower, and preferably the entire boot, that the present invention is particularly well-suited. Because the lower is sealed in a waterproof manner prior to closing the bottom opening 22, the at least one seam 14 and the second seam 32 can be easily accessed through the bottom of the boot. Particular reference is made to FIG. 4. This provides several advantages over prior art methods which first form the sole or footbed of the footwear and only then insert liners or attempt to seal any seams which have been formed. These advantages are further illustrated by FIG. 4, which shows a boot made being made according to the present invention wherein the bottom opening 22 has not yet been sealed. First, the bottom opening 22 of the lower is larger than the opening 40 through which a foot is inserted. Second, the seams 14 and 32 which need to be sealed watertight are typically disposed closer to the sole of the footwear. This is especially true when the footwear involved is a boot. Additionally, the foot portion of the footwear has more room in which to maneuver both the apparatus for applying a waterproof sealant and the instrumentality wielding the apparatus. Lastly, and perhaps most importantly, the seams 14 and 32 that are to be sealed can be directly observed as they are sealed. Not only does this remove error in applying the sealant, the watertightness of the seams 14 and 32 is also easier to check under direct observation.

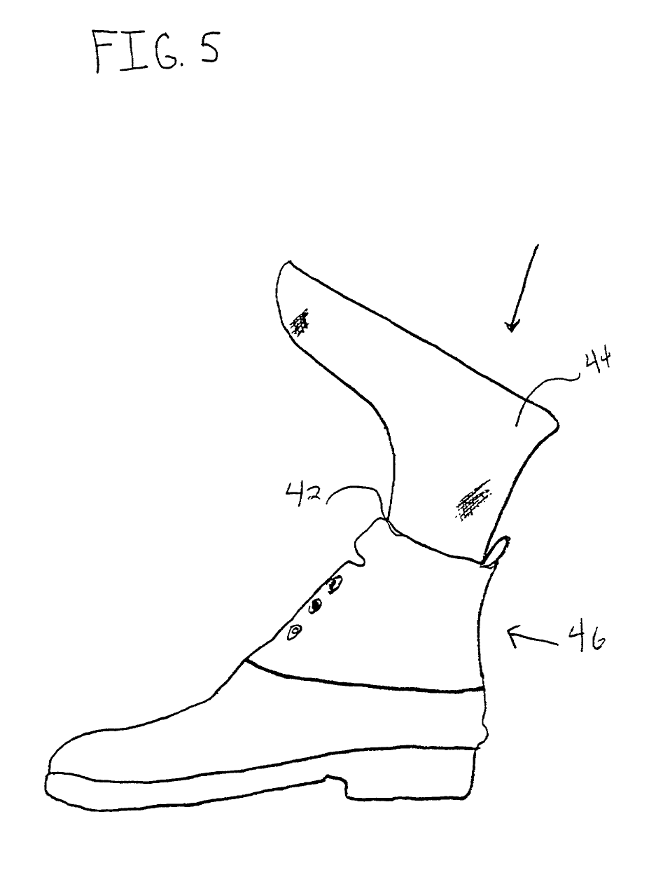

When a liner 34 is inserted into the boot through the bottom opening 22, a more precise fit can be obtained because the exact dimensions of the interior of the boot can be directly measured. This is advantageous over prior art methods of inserting liners into footwear because the prior art involves attaching an inverted liner to the top rim portion 42 of a boot and pushing the liner 44 into the boot 46 through the upper opening as illustrated in FIG. 5. This prior art method involves a fair amount of guess work and estimation which often leads to a less than perfect fit, especially when bulkier, insulating liners are used. The present method overcomes these problems and allows a manufacturer to obtain a precise fit for lining 34 by inserting the liner through the bottom opening 22 of the footwear and directly observing the fit of the liner 34. This is particularly advantageous where the footwear is custom made for an individual user, or where more precise fitting, such as through ½ sizes, is desired. Building footwear according to the present invention can be regarded as manufacturing footwear from the inside out rather than prior art methods which construct footwear from the outside in.

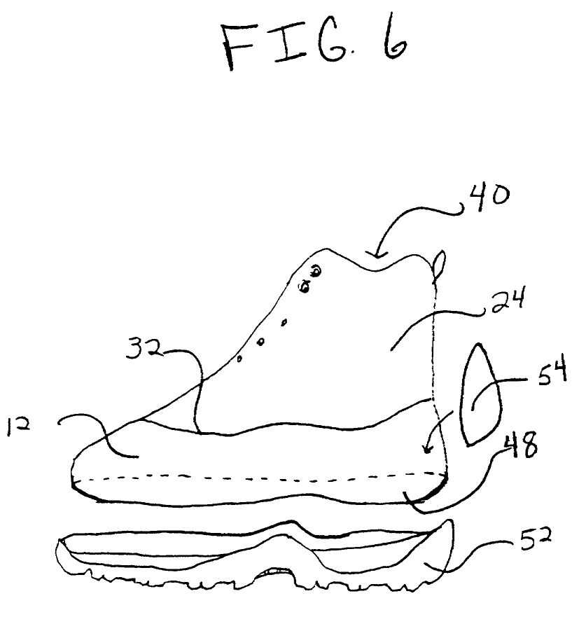

As shown in FIG. 6, an additional step in constructing footwear according to the present invention involves sealing the bottom opening 22 of the lower to form a sole 48, alternatively termed a footbed, for the footwear. Sealing the bottom opening 22 can be performed in a number of ways recognized in the art. Preferably, the bottom opening 22 of the footwear is sealed watertight by attaching a gasket 50, which preferably consists of waterproof material, completely over the bottom opening 22. Further protection, including waterproof protection, can be achieved for seam 14 by attaching a heel cap 54 over the heel portion and seam 14 of the footwear. Preferably, the heel cap 54 is of waterproof material. After the gasket 50 seals the bottom opening of the footwear, typically an outsole 52, which is also preferably waterproof, is attached completely over the gasket 50 and preferably rides up over at least a portion of lower 12. Alternatively, the bottom opening 22 can be completely sealed by placing the outsole 52, which can be a lug outsole, completely over the bottom opening 22. The gasket 50, outsole 52 and/or heel cap 54 can be attached in a number of ways known in the art, including, for example, stitching. However, preferably these pieces are attached to the footwear using a suitable waterproof adhesive such as rubber cement. Using an adhesive instead of stitches to attach gasket 50, outsole 52 and heel cap, eliminates potential points for water to infiltrate into the boot while at that same time eliminates the need to seal the stitched seams. To enhance the waterproof characteristics of the footwear, the sealing of the bottom opening 22 is preferably done in a completely waterproof manner. To provide superior waterproof protection for the wearer of the footwear, both the gasket 50 and the outsole 52 can be independently attached to the completed footwear in a waterproof manner thereby providing an extra measure of waterproof protection. Optionally, the footwear of the present invention can also include a midsole, support elements, or the like to finish the footwear as desired for use.

While preferred embodiments have been illustrated and described, it should be understood that changes and modifications can be made therein in accordance with ordinary skill in the art without departing from the invention in its broader aspects as defined in the following claims.

What is claimed is:

1. A method of constructing an article of waterproof footwear, comprising:
(a) shaping a lower from at least one piece of material by joining the material with at least one seam, wherein the lower has an upper circumference that defines a top opening and a lower circumference that defines a bottom opening;
(b) attaching the upper circumference of the lower to a complementary lower portion of an upper to form a second seam;
(c) sealing at least the lower in a waterproof manner; and
(d) sealing the bottom opening of the lower to form a footbed of an article of waterproof footwear.

2. The method of claim 1 further comprising attaching an outsole to the footbed of the article of waterproof footwear.

3. The method of claim 1 wherein the material comprises waterproof material.

4. The method of claim 1 wherein the material is substantially planar.

5. The method of claim 3 wherein the waterproof material consists of a single piece of waterproof material.

6. The method of claim 5 wherein the waterproof material is selected from the group consisting of rubber, polymers, and waterproof leather.

7. The method of claim 6 wherein the waterproof material selected is rubber and the rubber is molded rubber.

8. The method of claim 6 wherein the waterproof material selected is rubber further comprising vulcanizing the rubber.

9. The method of claim 1 wherein the at least one seam and the second seam are sealed by stitching.

10. The method of claim 9 wherein the material consists of rubber that is capable of holding a stitch.

11. The method of claim 1 further comprising disposing a liner adjacent to an inner surface of the lower or an inner surface of the upper through the bottom opening of the lower and attaching the liner to the inner surface of the lower or the inner surface of the upper.

12. The method of claim 1 wherein sealing at least the lower in a waterproof manner is achieved by disposing a waterproof liner adjacent an interior surface of the lower through the bottom opening.

13. The method of claim 1 wherein sealing at least the lower in a waterproof manner is achieved by sealing the at least one seam and the second seam in a waterproof manner by accessing the at least one seam and the second seam through the bottom opening of the lower.

14. A method of constructing a waterproof boot, comprising:
(a) Forming a lower from a single piece of substantially planar, generally U-shaped piece of rubber by joining the open end of the generally U-shaped piece with a seam, the lower having an upper perimeter defining a top opening and a lower perimeter defining a bottom opening;
(b) attaching the perimeter of the upper portion of the lower and a complementary lower portion of an upper to form a seam connection;
(c) sealing the seam and the seam connection in a waterproof manner by accessing the seam and seam connection through the bottom opening of the lower; and
(d) sealing the bottom opening of the lower with a gasket in a waterproof manner to form a footbed of a waterproof boot.

15. The method of claim 14 wherein the seam is located in a heel portion of the waterproof boot.

16. The method of claim 14 further comprising joining a sole to the footbed of the waterproof boot.

17. The method of claim 14 further comprising vulcanizing the rubber.

18. The method of claim 14 wherein the seam and the seam connection are stitched.

19. The method of claim 14 wherein the single piece of substantially planar, generally U-shaped piece of rubber is molded rubber.

20. The method of claim 14 further comprising disposing a liner adjacent to an inner surface of the lower by accessing the inner surface of the lower through the bottom opening of the lower and attaching the liner to the inner surface of the lower.
